(19) United States
(12) Patent Application Publication
(10) Pub. No.: US 2008/0112394 A1
(43) Pub. Date: May 15, 2008

(54) SYSTEM, METHOD AND DEVICE FOR PROVIDING MOBILE VoIP

(75) Inventors: Shai Haim Gilboa, Atlit (IL); Daniel Fogel, Bat Yam (IL)

Correspondence Address: PILLSBURY WINTHROP SHAW PITTMAN, LLP, P.O. BOX 10500, MCLEAN, VA, 22102, US

(73) Assignee: AUDIOGATE TECHNOLOGIES LTD., Atlit (IL)

(21) Appl. No.: 11/937,893

(22) Filed: Nov. 9, 2007

Related U.S. Application Data
(60) Provisional application No. 60/865,173, filed on Nov. 10, 2006.

(51) Int. Cl. H04L 12/66

(52) U.S. Cl. 370/352

(57) ABSTRACT

An appliance connected to a cellular phone performs VoIP connectivity by using the cellular phone data connectivity platform. This expands the capabilities of regular cellular phones, and allows users to place and receive mobile VoIP phone calls using their older generation cellular phones.

This application claims priority to U.S. Provisional Application Ser. No. 60/865,173, filed Nov. 10, 2006, the entirety of which is incorporated herein by reference.

### FIELD OF INVENTION

The invention relates to a system, method, and device that provide VoIP (Voice over Internet Protocol) calling or access using a cellular phone not previously configured to transmit and receive verbal communication using an Internet Protocol methodology.

### BACKGROUND

Wired and wireless networks abound. These networks support communications around the world by permitting users employing different hardware and software configurations to communicate with each other through defined protocols. These protocols evolve over-time and new ones are used as well. Two existing protocols that may be used to communicate across networks include TCP/IP (Transmission Control Protocol/Internet Protocol) and UDP (User Datagram Protocol). There are numerous other standards in addition to these two.

Cellular phones communicate across wired and wireless networks. This is done in part through the use of various available telecommunication protocols. For example, one protocol may be used to communicate from a cellular phone to a base station while another protocol may be used by the base station to communicate over a wired network after receiving a transmission from a cellular phone. As technology develops, so to do the available protocols. This development may take place to leverage the improved technology, to unify existing protocols, and for other reasons as well. A result of this evolution in technology and protocols is that certain components in the network may not be able to use all available protocols and may not be able to provide all of the services that the improved or new protocols provide.

Examples of the protocols that cellular phones may use to connect to the cellular network include: Code Division Multiple Access (CDMA), Global System for Mobile (GSM), and Time Division Multiple Access (TDMA), etc. These protocols are most often used for voice calls. Additional protocols may also be needed to support data application connectivity, these could include Internet access and multimedia telecommunications. Data connectivity protocols include: General Packet Radio Service (GPRS), Enhanced GPRS, and Universal Mobile Telecommunications System (UMTS), GSM.

Voice over Internet Protocol (VoIP) has appeared as a use of Internet Protocol. VoIP provides for telephone-like voice conversation to be routed over the Internet or through an IP-based network. Older generation cellular phones, operating GSM, GPRS, UMTS or other data connectivity protocols, are not suited or configured for completing VoIP calls over an IP network.

Embodiments of the invention provide various innovations that enable older generation cellular phones to add VoIP connectivity or VoIP features not previously available on these phones.

### SUMMARY OF INVENTION

The current invention may comprise an appliance that is coupled to a cellular phone, such as a second generation cellular phone. This appliance may function in conjunction with the cellular phone to enable VoIP connectivity through a cellular phone data connectivity platform. In so doing, this older generation cellular phone may be adapted to function with and communicate using VoIP. This connectivity may also allow home and office users to make VoIP phone calls using their existing older generation cellular phones, via a wireless network platform, directly to an IP network. These calls may be made to other VoIP telephones, VoIP devices, and VoIP software telephones (“softphones”) which are connected to the IP network and can support the IP protocols. These calls may also be made to the existing PSTN. This may be done through a translation of the VoIP protocol to analog or digital Pulse Code Modulation (PCM) protocol by a gateway connecting the IP network and the PSTN.

An appliance of the invention may use an older generation cellular phone's data connectivity capabilities to run the VoIP packets to the IP network. This may be done using GPRS, UMTS or other data protocol run by the older generation cellular phone.

The appliance may also use the speaker or microphone capabilities of the cellular phone to permit voice conversations and reduce the need for redundant functionalities. The appliance may include a standard connector for headsets, speaker phone and phone charger.

In so doing, the capabilities of older generation cellular phones may be expanded, and users may be permitted to make and receive mobile VoIP calls using older generation cellular phones not previously configured to do so.

Other objects, features, and advantages of one or more embodiments are provided in the following detailed description, accompanying drawings, and appended claims. Still further embodiments of the invention, from the teachings provided herein, are also plausible.

### BRIEF DESCRIPTION OF THE DRAWINGS

Embodiments of the present invention will now be disclosed, by way of example only, with reference to the accompanying schematic drawings where corresponding reference symbols indicate corresponding parts, in which:

FIG. 1 shows the general architecture of a cellular phone and IP network, in accordance with an embodiment of the present invention;

FIG. 2 shows a cellular phone and the VoIP appliance in accordance with an embodiment of the present invention;

FIG. 3 shows the cellular network based on GSM and GPRS in accordance with an embodiment of the present invention;

FIG. 4 shows the hardware and software architecture of the VoIP appliance, in accordance with an embodiment of the present invention;

FIG. 5 shows an example of a 14-pin layout connector to the cellular phone in accordance with an embodiment of the present invention; and

FIG. 6 is a flowchart for the steps for making a VoIP phone call that may be undertaken, in accordance with an embodiment of the present invention.

### DETAILED DESCRIPTION OF INVENTION

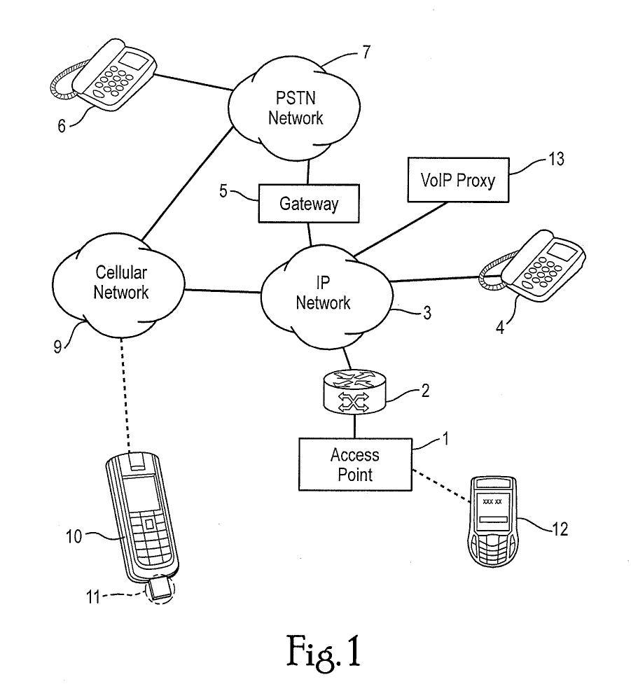

FIG. 1 shows the architecture of an older generation cellular phone and IP network as may be employed by embodiments of the present invention. An older generation cellular phone 10 is shown. This phone 10 may wirelessly connect to the cellular network 9. The cellular network 9 may be connected to an IP network 3, which can be the public Internet or any other IP-based network. A VoIP appliance 11 is shown connected through the older generation cellular phone 10 to the cellular network 9. The appliance 11 may be used to initiate a data connection to the IP network 3, by the cellular phone 10. This may be done by initiating a data connection over the cellular network 9. After an IP connection is initiated by the cellular phone 10 to the IP network 3, the appliance 11 may use this data connection in order to connect to a VoIP proxy 13 of an Internet Telephony Service Provider (ITSP) including any registration and authentication. In so doing, the older generation phone may now be used to communicate over the ITSP with the additional assistance of the appliance 11.

Other telephony devices may also provided in the architecture. For example, an IP phone 4 may be connected directly to the IP network 3, and may be used to receive and initiate VoIP calls. A mobile phone device 12, such as a Blackberry® device, may be connected to the IP network 3 via a wireless access point 1 and node 2 and may receive VoIP calls over the network. The node 2 may be a router or other gateway to the IP network 3. The mobile phone device 12 can also receive and initiate VoIP calls. Similarly, a PSTN phone 6 may also be connected via a PSTN network 7. The PSTN network may be connected to both the cellular network 9 and the IP network 3 via a gateway 5.

VoIP calls can be initiated between the appliance 11, via the cellular phone 10, to any telephony device capable of receiving VoIP calls, e.g. IP phone 4 and/or IP mobile phone 12. Calls may be a peer-to-peer VoIP call between the telephony devices, or via the VoIP proxy 13. The cellular phone 10 and appliance 11 may also initiate VoIP calls, which are terminated in the PSTN 7, after being converted from the VoIP protocol to analog or digital Pulse Code Modulation (PCM) protocol by the gateway 5. Calls may also be initiated in the opposite direction, i.e., the call is initiated by the regular PSTN phone 6 to the appliance 11, via the PSTN 7, gateway 5, IP network 3 and cellular network 9.

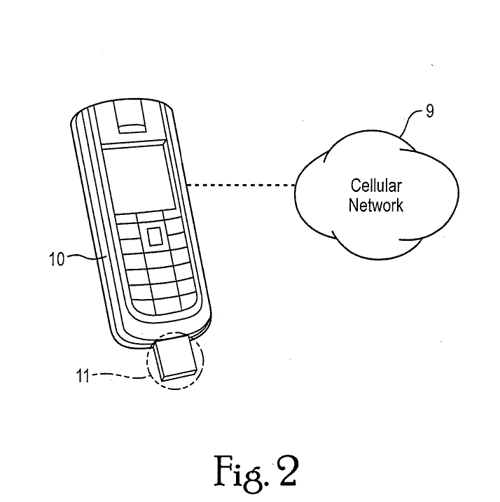

As shown in FIG. 2, the appliance 11 may be connected to the cellular phone 10 via an external connection of the cellular phone. The appliance 11 may be a dongle or any plug-in device which externally connects to a communications connector (e.g., data port) of an older generation cellular phone 10, for example, by a plug-in connection. A number of different plug-in connectors may be provided to accommodate the many cellular phone manufacturers and models.

The cellular phone 10 may be connected to the cellular network 9 with a data connection protocol such as GPRS, UMTS, etc. This connection allows the VoIP appliance 11 to initiate and receive VoIP calls to VoIP networks and phones out of the cellular network with the assistance of the cellular phone 10.

The older generation cellular phone may be communicating with GSM or GPRS. GSM is considered a second generation (2G) mobile phone standard. GPRS is considered a second and a half generation (2.5G), and it is a mobile data service upgrade to a GSM mobile phone network. This provides users with packet data services over a GSM network. Each voice circuit in GSM network transmits speech on a secure 14 kbps digital radio link between the mobile phone and a nearby GSM transceiver station. The GPRS service joins together multiple speech channels to provide higher bandwidth data connections for GPRS data users. The radio bandwidth remains the same, but is shared between the voice users and the data users. The network operator has the choice of prioritizing voice over data, or vice-versa. GPRS users may also benefit from being able to use GPRS while traveling as the GSM system should transparently hand over the GPRS connection from one base station to another.

The primary use for GPRS is to send and receive data for computer applications. GPRS facilitates instant connections whereby information can be sent or received immediately, only as the need arises (and subject to radio coverage). No dial-up connection is necessary like GSM. GPRS charges by amount of data sent rather than connect time. To use GPRS, the service is initiated (although there is no telephone number) at which point the user is “attached” to the network and an IP address is allocated. From then on data can flow to and from the Internet until either the network unattaches or releases the user (e.g., due to a time-out, fault or network congestion) or the user manually unattaches from or releases the network. Initiating a data connection by a cellular phone may be performed by the user, pressing on buttons of the keypad, for example, to initiate an Internet browsing, to send an email, text or instant message, etc. In the present invention, the data connection is initiated through the appliance 11 with the assistance of the cellular phone 10.

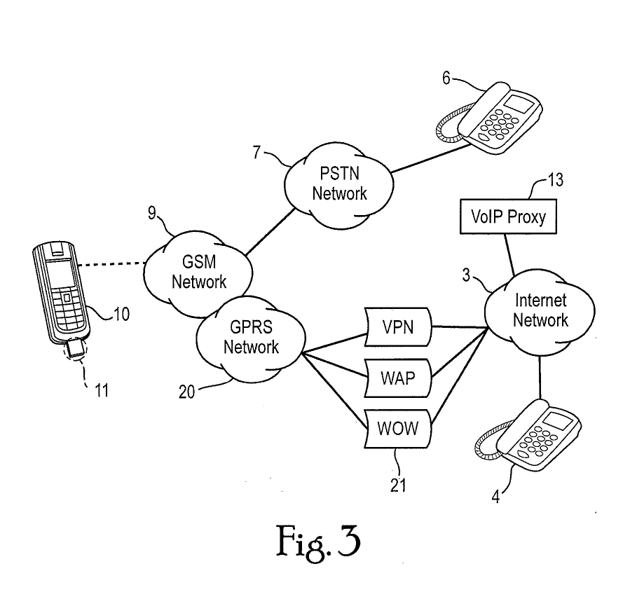

FIG. 3 shows one embodiment of the invention for connection to a cellular network based on the GSM and GPRS protocols, connected to the public Internet. The VoIP appliance 11, is connected to the cellular phone 10. The cellular phone 10 is connected to the GSM cellular network 9, and the GPRS network 20. The GPRS network 20 in-turn may be connected to the public IP network 3 via optional gateways 21, such as a Virtual Private Network (VPN) gateway, Wireless Application Protocol (WAP) gateway, and World Wide Web (WWW) gateway.

An IP phone 4, which supports VoIP, may also be connected directly to the public IP network 3. VoIP calls can be initiated between the VoIP appliance 11, and the IP phone 4, via the GSM 9, GPRS 20 and IP network 3. The VoIP protocol may be any protocol that is available, such as Session Initiation Protocol (SIP), Media Gateway Control Protocol (MGCP), H.323 protocol, Inter Asterisk eXchange protocol (IAX), Gateway Control Protocol (MEGACO), and Skinny Call Control Protocol (Cisco SCCP). The VoIP connectivity may also be initiated via the VPN gateway or WWW gateway 21, which connects the GPRS network 20 and the IP network 3. Also a PSTN phone 6 may be connected to the GSM network 9 through a PSTN 7.

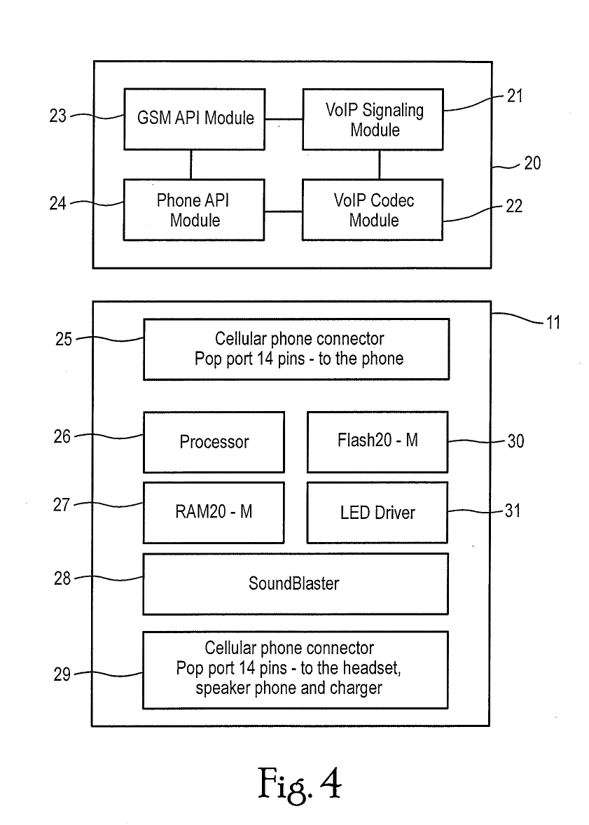

FIG. 4 shows a schematic of one embodiment of the appliance 11. The appliance 11 may include: a processor 26, Random Access Memory (RAM) 27, a SoundBlaster (i.e., a converter between a speaker and a microphone outputs to PCM data) unit 28, Flash memory 30, an LED unit 31, and additional connector 29 to connect to external headsets, speaker phone and/or power charger. The appliance 11 may be configured with circuits and software, which may run executable programs, such as VoIP softphones.

The processor 26 may run a VoIP software module 20, and may comprise dedicated hardware, e.g., a microprocessor, software, or a combination of dedicated hardware, and software. The software module 20 may include: a VoIP signaling protocol stack module 21, a VoIP Code/Decode (Codec) module 22, a GSM Application Interface (API) module 23, and the cellular phone API 24. The software module 20 may be any machine or computer executable instructions stored in a memory, e.g., RAM 27 or flash memory 30. When the cellular phone 10 is powered up, the processor 26 reads the executable application code from VoIP software module 20 from the flash memory 30, and may initiate the appliance including components: sound blaster 28, LED 31, memory data, and the software modules 21, 22, 23, 24. In this state, the appliance is using the phone API module 24 to display texts on the phone display, to receive indications from the phone when a keypad button is pressed, or a menu softkey is pressed, in any specific menu state.

The software module 20 supplements the cellular phone's software. In one embodiment, the VoIP signaling protocol stack module 21 includes the instructions necessary to connect to the VoIP proxy 13 and establish a VoIP call. The VoIP Codec module 22 includes the instructions necessary to convert analog voice signals from cellular phone 10 to packet data, and vice-versa. Together, the VoIP signaling module 21 and VoIP Codec module 22 may also be configured to follow one or more specific VoIP protocols, for example the H.323 or SIP protocol. In so doing, existing functionality in the cellular phone may be supplemented or superseded during a VoIP call with the proper signaling protocol and current Codec inscription scheme of the VoIP protocol being used by the appliance 11 and being run by the software module 20 rather than the Codec functionality originally programmed with the cellular phone.

The GSM API module 23 may include all of the instructions necessary to establish and maintain a data connection to the Internet service provider using a cellular network 9. The cellular phone API 24 may include all of the instructions necessary to take control of the dialing functionality (and other functions) of the cellular phone 10.

Advantages of these configurations include lower energy demands, because the appliance 11 uses the cellular phone 10 efficient GPRS functions, and does not generate its own GPRS or Wi-Fi connection, which are energy consuming. Another advantage of this embodiment is that while having a VoIP call, a parallel GSM call may be received, and a “Flip Over” function may be activated to switch between the VoIP call and the GSM calls.

The appliance 11 includes a first connector 25 that is connected to the cellular phone 10. The connector 25 may be, for example, a 14-pin connector. A second connector 29 may be used to accommodate an accessory, e.g., a microphone, battery charger, speaker phone, and/or to be connected to the appliance 11. The second connector 29 may be identical to connector 25, although it does not need to be.

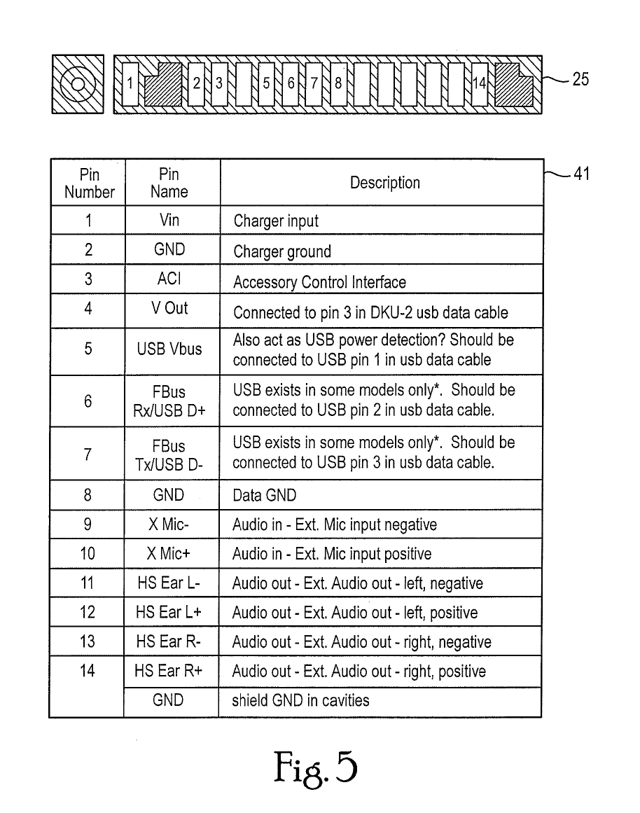

FIG. 5 shows one embodiment for a 14-pin layout connector 25 for use with the appliance 11. Each pin's function is described in table 41. Appliance 11 uses the phone API module 24 to take control of the dialing functionality of the keypad of the cellular phone, using pins 3 and 6-7. When a telephone number is dialed via the keypad, and the “send” button is pressed by the user, the appliance 11 receives the dialed digits using pins 3 and 6-7, and initiates the call to that telephone number. The appliance 11 may optionally perform some manipulations to dialed telephone number (e.g., adding a dialing prefix), if necessary.

The GSM API module 23 and the phone API module 24 may take control of the GPRS (or UMTS or other) connection activation of the cellular phone 10. For example, the appliance 11 may use the phone GSM API module 23 via pins 3 and 6-7 to command the cellular phone 10 to establish and maintain a 2.5G or 3-3.5-4G data connection to the Internet service provider with applicable protocols via cellular network 9 using the older generation cellular phone 10. And, pins 9-14 may be configured to receive and transmit analog voice signals from the speaker and microphone of the cellular phone 10 to the VoIP Codec module 22.

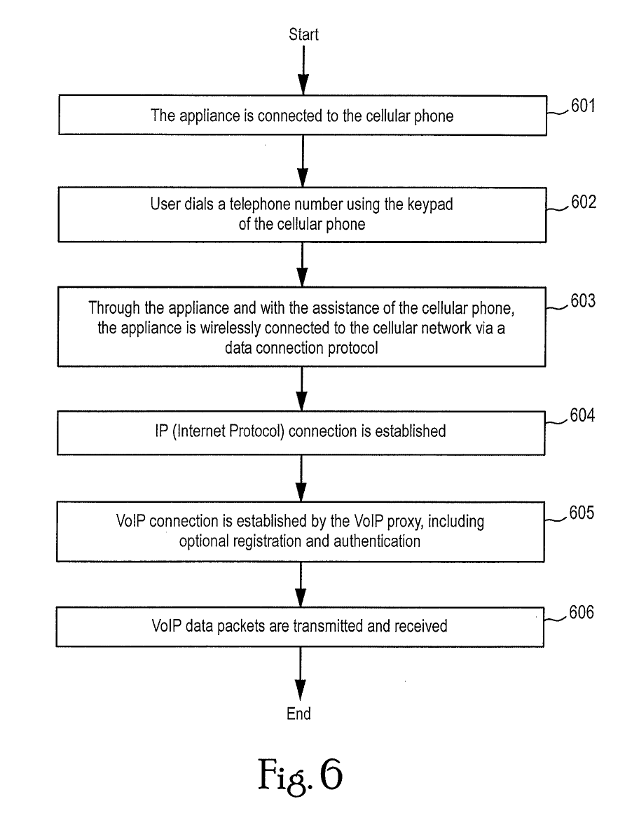

FIG. 6 shows a flow chart of the steps for making a VoIP phone call, in accordance with an embodiment of the invention. First, in step 601, the appliance 11 is connected to the cellular phone 10, for example, by the 14-pin connector 25. In step 602, the user may initiate calls by dialing a telephone number via the keypad of the cellular phone. The dialing information (e.g., telephone number digits) inputted by the user may be transmitted to the appliance 11 which may assume control of the keypad dialing signals through the phone API module 24. In step 603, through the appliance 11 and along with the assistance of the cellular phone 10, a data connection may be initiated by the cellular phone 10 using the phone API module 24 and the GSM API module 23, for example using GPRS via the GSM network 9. The GPRS enables the VoIP call over a data connection layer. In step 604, once the data connection is established, the IP network 3 may be made available through the cellular service provider. The IP network 3 may utilize Internet Protocol Version 4 (IPv4) and/or IP version 6 (IPv6). In Step 605, the VoIP signaling module 21 may connect to the VoIP proxy 13 including optional registration and authentication. After registration is performed, the VoIP Signaling module 21 may activate the LED 31.

In one embodiment, user VoIP profile data for an ITSP may be previously inputted and saved in the appliance's memory by using the phone keypad and display. The user VoIP profile data may include, among other thing: a VoIP proxy IP address, a user name, a password, etc.

The appliance 11 initiates the VoIP call to the desired destination telephone number using the VoIP protocol channel which was initiated by the ITSP, i.e., the VoIP proxy 13. The VoIP call may be initiated using any VoIP protocols, for example, Session Initiation Protocol (SIP), Media Gateway Control, Protocol (MGCP), H.323, etc.

In step 606, once the VoIP connection with a remote telephone is established, the appliance 11 transmits and receives Real Time Transport Protocol (RTP) VoIP packet data and a telephone-like voice conversation can take place between the two devices. In one embodiment, the user may use the speaker and microphone of the cellular telephone 10 for conversing. The user may also connect a head set or speakerphone to the appliance 11, via the connector 29. In this example, the VoIP packets are transmitted and received from/by the appliance 11 to the cellular phone 10 via pins 6 and 7 of the connector 25.

The VoIP data packets are transmitted via the 2.5-3.5-3.75-4G data layer and may include two main protocols: 1) VoIP signaling data, which establishes the logic connection to the ITSP, and 2) media packets, such as Real-Time Transpsort Protocol (RTP) which transmits the VoIP speech. The data packets used by VoIP are transparent to the cellular service provider, because the cellular network sees the VoIP as a standard IP communication—like a standard web browsing (e.g., using TCP or UDP protocols), which is possible by any phone which supports GPRS or other 2.5-4G technology.

Voice received by the microphone of cellular telephone 10 may be converted to an analog signal and transmitted to the appliance 11 via the audio-in pins 9-10 of the connector 25. The VoIP Codec module 22 converts the analog voice signal to data packets, for example using the RTP protocol, and sends them via the established data path connected via the data pins 6-7 to the cellular phone 10 and via the 2.5-4 data layer to the VoIP provider.

In the opposite direction, RTP packets that are sent from the service provider over the data channel are received by the appliance 11 via the data pins 6-7 and converted to an analog signal by the VoIP Codec module 22. The analog voice signal may be then transmitted via the audio-out pins 11-14 of the connector 25 and played on the speaker of the cellular telephone 10, or played on external speaker which is connected to connector 29 in FIG. 4.

The following example assumes that the appliance 11 uses the Session Initiation Protocol (SIP) as the VoIP protocol. The scenario provides one example of a call flow, one of many possible. The VoIP Signaling Module 21 sends an Invite message to the VoIP proxy 13, via the data connection initiated previously. If the dialed number is valid, the VoIP proxy 13 sends an Invite message to the relevant destination network. Then, if the destination phone is also available and ready, it will start ringing, and a “180 Ringing” message will be sent by the VoIP proxy 13 back to the appliance 11 via the data connection. The appliance 11 will send a relevant “Ringing” display text via the Phone API Module 24, which will be displayed on the cellular phone display.

When the remote side answers the phone, a “200 OK” message will be sent from the VoIP proxy 13 to the VoIP Signaling Module 21. Then, the VoIP Codec Module 22 will initiate a Real Time Transport Protocol (RTP) session with the destination phone, by using Session Description Protocol (SDP). The relevant codec will be chosen for the call, and RTP data packets of speech will be sent and received by the VoIP Codec module 22 on the data channel to the VoIP proxy 13.

Throughout the VoIP phone call, the phone API module 24 may control the LCD display on the cellular phone to display the telephone number and indicate the status call (e.g., the duration of the call). From the user's perspective, it appears as if the user is making an ordinary telephone call using a regular cellular phone 10. The appliance 11 may be capable of handing off the transmission of communication between different communication paths and protocols seamlessly.

Embodiments may be used with 2.5G, 3G and even 3.5-3.75-4G regular cellular phones which do not support VoIP, and in some of cases do not support video. It is important to understand that even though a cellular phone supports video, the cost of the video call is at least the cost of a regular GSM call. The invention may used over the 2.5-3.5-3.75-4G data layer, for very cheap calls. Thus, embodiments of the invention provide for more economical methods of communication for users of cellular phones. The user may pay for the data package he purchases. By using it for VoIP, the user receives a very low cost per minute voice call, compared to a regular GSM call.

While this invention has been described in connection with what is presently considered to be the most practical and preferred embodiment, it is to be understood that it is capable of further modifications and is not to be limited to the disclosed embodiments. This application is intended to cover any variations, uses, equivalent arrangements or adaptations of the invention following, in general, the principles of the invention and including such departures from the present disclosure as come within known or customary practice in the art to which the invention pertains, and as may be applied to the essential features hereinbefore set forth and followed in the spirit and scope of the appended claims.

What is claimed is:

1. An appliance device for connecting to a cellular telephone and permitting a Voice over Internet Protocol (VoIP) phone call, the device comprising:
an appliance having a connector configured to removable secure the appliance to external electrical contacts of a cellular phone, the appliance also having one or more accessible electrical contacts sized and positioned to meet with external electrical contacts of a cellular phone;
a software module contained in the appliance, the software module comprising machine readable instructions that along with the assistance of the cellular phone, is adapted to: control the dialing functionality of the cellular phone, establish and maintain a data connection via a cellular network, and establish and complete a VoIP phone call.

2. The device according to claim 1, wherein the software module further comprises machine readable instructions for converting an analog voice signal to packet data.

3. The device according to claim 1 wherein the software module contains instructions to enable a cellular phone configured to communicate over a GSM network to communicate over a data packet network.

4. The device according to claim 3, wherein the data packet network is GPRS.

5. The device according to claim 1, further comprising an additional connector for connecting an external accessory to the appliance.

6. The device according to claim 5 wherein the external accessory is a microphone, battery charger, speaker, and/or a headset.

7. The device according to claim 1 wherein the software module further comprises machine instructions for adapting the coding and decoding of analog or digital voice signals in a CODEC to digital packet data in compliance with a VoIP protocol.

8. The device according to claim 1, wherein the software module further comprises machine readable instructions for performing connection and authentication with an Internet Telephony Service Provider (ITSP).

9. The device according to claim 1, wherein the machine readable instructions establish a VoIP call using of one the following VoIP protocols: Session Initiation Protocol (SIP), Media Gateway Control Protocol (MGCP), H.323 protocol, Inter Asterisk eXchange protocol (IAX), Gateway Control Protocol (MEGACO), and Skinny Call Control Protocol (Cisco SCCP).

10. The device according to claim 1, wherein the software module further comprises machine readable instructions to support a VoIP communication using Internet Protocol Version 4 (IPv4) or Internet Protocol Version 6 (IPv6).

11. The device according to claim 1, wherein the software module contains machine readable instructions for having voice data transmitted in data packets during a VoIP call using Real-Time Transport Protocol.

12. The device according to claim 7 wherein the VoIP protocol is H.323 protocol.

13. The device according to claim 1, wherein the machine readable instructions include instructions to obtain a VoIP proxy over an Internet Protocol network.

14. The device according to claim 1, wherein the machine readable instructions also enable the cellular phone to continue to send and receive communications over a non-IP communication protocol.

15. The device according to claim 1 wherein the data connection established by the cellular phone is based on second generation (2G) mobile communications standards, third generation (3G) mobile communications standards, or fourth generation mobile communications standards (pre-4G and 4G).

16. A method for making Voice over Internet Protocol (VoIP) phone calls using a cellular telephone:
connecting an appliance to a connection of a cellular phone;
dialing a telephone number;
sending instructions from the appliance to the cellular phone to establish a data connection using the cellular phone, the data connection established carries VoIP protocol packets;
sending data packets from the appliance to the cellular phone to establish a VoIP connection using the established data connection, the VoIP connection establishing a VoIP proxy at a location in an Internet Protocol network remote from the cellular phone; and
transmitting VoIP data packets using digital encoding and decoding techniques of a VoIP protocol.

17. The method of claim 16 wherein the VoIP protocol is H.323.

18. The method of claim 16 wherein the VoIP protocol is one of the following protocols: Session Initiation Protocol (SIP), Media Gateway Control Protocol (MGCP), H.323 protocol, Inter Asterisk eXchange protocol (IAX), Gateway Control Protocol (MEGACO), and Skinny Call Control Protocol (Cisco SCCP).

19. The method of claim 16 further comprising:
generating signaling instructions for VoIP communication in the appliance and broadcasting those instructions with an antennae of the cellular phone.

20. The method of claim 16 further comprising:
receiving signals at the appliance from the cellular phone representing touchtone signals of a telephone number, and
generating signals in the appliance to establish the VoIP proxy for voice communications with the telephone number identified by the received touchtone signals.

21. The method of claim 16 wherein prior to connecting the appliance to the cellular phone, the cellular phone contains instructions for sending and receiving cellular communications using the GSM protocol, CDMA protocol or TDMA protocol.

22. The method of claim 16 wherein an external microphone, battery charger, speakers and/or headsets are connected to the appliance.

23. The method of claim 16 wherein the data connection established by the cellular phone is based on second generation (2G) mobile communications standards, third generation (3G) mobile communications standards, or fourth generation mobile communications standards (pre-4G and 4G).
